(19) United States
(12) Patent Application Publication
(10) Pub. No.: US 2016/0123616 A1
(43) Pub. Date: May 5, 2016

(54) CONTROLLED HEAT DELIVERY

(71) Applicant: HEWLETT-PACKARD DEVELOPMENT COMPANY, L.P., Houston, TX (US)

(72) Inventors: Brian R Graham, Boise, ID (US); James BLASCHKE, Houston, TX (US); Lawton J. KAINER, Houston, TX (US); Dave ROTHEROE, Austin, TX (US); Josef REPSCH, El Segundo, CA (US); David STEELE, San Francisco, CA (US)

(21) Appl. No.: 14/429,489

(22) PCT Filed: Jan. 31, 2013
(86) PCT No.: PCT/US2013/024210

§ 371 Date: Mar. 19, 2015

(51) Int. Cl. F24F 11/00; G05B 15/02

(52) U.S. Cl. CPC F24F 11/006; G05B 15/02

(57) ABSTRACT

A system for controlling heat delivery including at least one heating element to generate heat, at least one power regulating device to regulate the amount of energy output to the at least one heat element, at least one monitor device to measure environmental parameter data of the at least one power regulating device and the at, least one heating element, a data processing computer to process environment parameter data from the at least one monitor and initial setting data and provide operating instructions, and at least one control device to receive the operating instructions from the data processor and control the at least one power regulating device to regulate energy output to the at least one heating element.

### BACKGROUND

Data centers are parts of buildings or facilities in which a number of computing and networking IT equipment, such as server computers, are typically mounted in racks arranged within the data center. The server computers and other equipment in the racks generate large amounts of heat. Heat load modeling can provide information on operations of data processing facilities. Typically, modeling heat dissipation in data processing environments utilizes resistive and/or inductive types of load banks in which power output is controlled in large steps (e.g., 0-25%-50%-100%) by electro-mechanical devices and/or by manual selection of power output quantities.

### BRIEF DESCRIPTION OF THE DRAWINGS

FIG. 1 is a block diagram of an example system for controlling heat delivery.

FIG. 2 is a block diagram of an example data processing computer of an example system.

FIG. 3 is a block diagram of an example system for controlling heat delivery.

FIGS. 4A and 4B are diagrams of an example system or controlling heat delivery in a data center.

FIG. 5 is a flow chart illustrating an example method for controlling heat delivery.

FIG. 6 is a flow chart illustrating an example method for controlling heat delivery.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims, It is to be understood that features of the various examples described herein may be combined, in part or whole, with each other, unless specifically noted otherwise.

Simulated models of heat generation operations in controlled environments provide information to designers and others. Testing, metering, and equipment commissioning in structured environments, such as data processing facilities (e.g., data centers) can deliver heat that, for example, can be generated by heating devices to simulate real servers. Examples provide systems and methods of controlled heat delivery for data center equipment performance analysis.

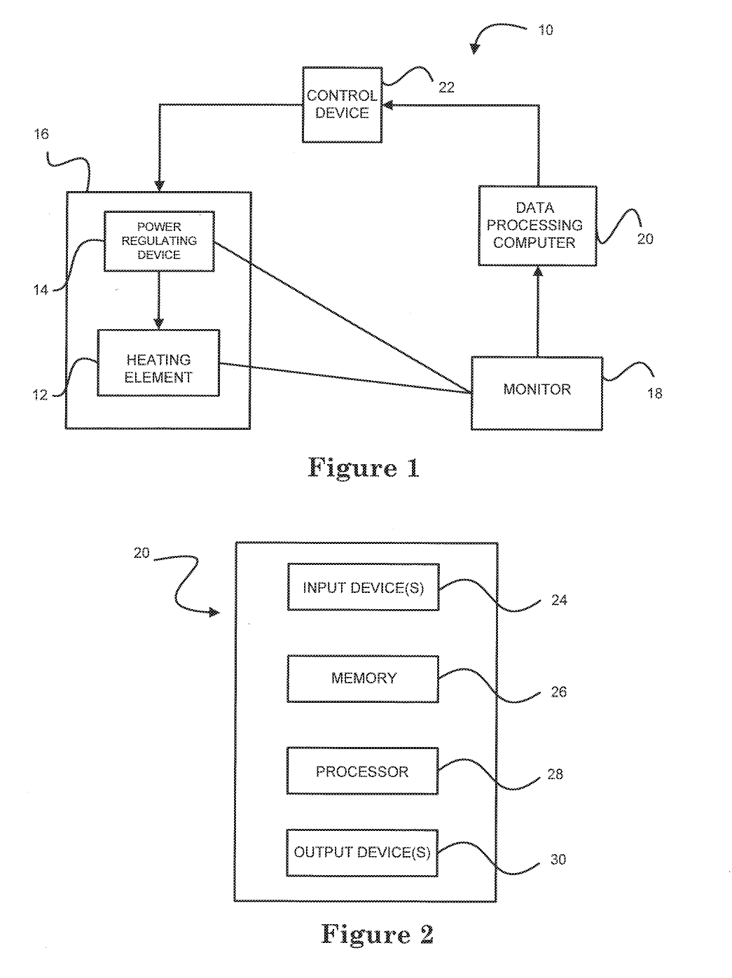

FIG. 1 illustrates a block diagram of an example system 10 for controlling heat delivery. System 10 includes heating elements 12 and power regulating devices 14 housed in rack(s) 16. A monitor 18 is employed to measure at least one environmental parameter, such as air velocity, air pressure, and temperature. Measured environmental parameter data is communicated from monitor 18 to a data processing computer 20. Data processing computer 20 receives, stores, and processes data, including initial input data and the environmental parameter data received from monitors 18. Data processing computer 20 provides operating instructions and communicates the operating instructions to a control device 22. Control device 22 transmits control instructions to power regulating devices 14 based on the operating instructions. Power regulating devices 14 regulates the amount of energy delivered to corresponding heating elements 12.

In one embodiment, heating element 12 is a ceramic encased heating element that simulates server heat load. Each heating element 12 is controllable, via control device 22 and its corresponding power regulating device 14, to produce varying, amounts of heat. Power regulating device 14 can be a triode of alternating current (TRIAC) device, for example. Other power regulating devices configured to controllably deliver specific amounts of energy to multiple heating elements, singly or in combination, via a control device are also suitable.

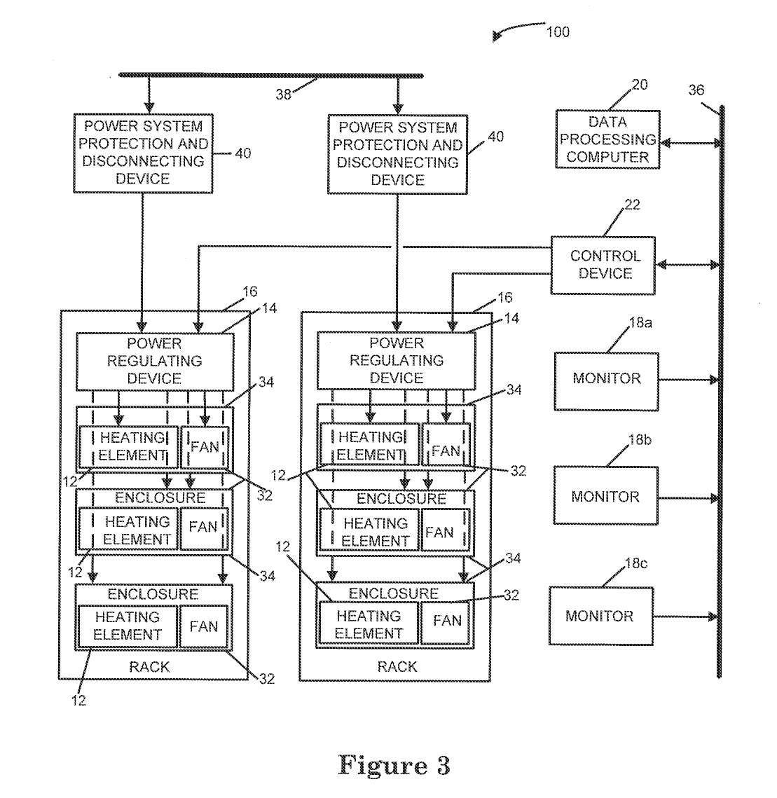

FIG. 2 illustrates a block diagram of an example data processing computer 20. Data processing computer 20 includes input device(s) 24, a memory 26, a processor 28, and output device(s) 30. Input device(s) 24 receive initial input data, such as equipment characteristic data and load parameters, and environmental parameter data (e.g., air velocity, air pressure, and temperature). Memory 26 is suitable for storing data and parameters, operating system software, application software, and other instructions. Data processing computer 20 can include other removable and/or non-removable storage where memory 26, the non-removable storage, and the removable storage are implemented in computer readable storage media. Memory 26 and the other computer readable media in data processing computer 20 can include volatile and/or non-volatile storage memory.

Processor 28 executes instructions stored in memory 26. Processor 28 processes input data received via input device(s) 24 and stored in memory 26 and provides operating instructions. In one embodiment, processor 28 employs a generational quantizational technique to provide the operating instructions. After the instructions are generated, output device(s) 30 transmit the operating instructions to control device 22.

FIG. 3 illustrates a block diagram of a system 100 for controlling heat delivery. System 100 includes multiple racks 16, each housing at least one heating element 12 and at least one fan 32. In one embodiment, each rack 16 houses multiple heating elements 12 and multiple fans 32. A specific amount or range of thermal demand to be generated by the entire system 100, a specific rack 16, and/or specific heating elements 12 can be selected initially, as well as during operation of system 100, by an operator. One or more environmental parameter set points can be specifically defined for system 100 which are indicative of thermal demand. In real time operation, however, heating elements 12 in racks 16 would not predictably generate the selected amount of thermal demand, as indicated by real time measured environmental parameter data, and adjustments to achieve the desired thermal demand level can follow.

Monitors 18a-18c provide environmental data to further characterize the local environmental parameters of racks 16 and heating elements 12, locally, and/or the environmental parameters of system 100 as a whole. Monitors 18a-18c are strategically located in racks 16 to measure the environmental parameters associated with specific racks 16 and/or heating elements 12 within racks 16. Monitors 18a-18c measure and transmit environmental parameter data of their respective locations. Monitors 18a-18c are operable to measure at least one environmental parameter. In one embodiment, monitors 18a-18c are configured to wirelessly transmit measured environmental parameter data to a data communication bus 36 or directly to data processing computer 20.

Data processing computer 20 provides and transmits operating instructions to control device 22. Control device 22 is responsive to the operating instructions to provide control instructions to power regulating device 14 to control specific amounts of energy supplied to at least one heating element 12 and/or specific control of at least one fan 32. Fans 32 are controllable to produce varying amounts of airflow. In one embodiment, the operating instructions from data processing computer 20 specify output amperage supplied to heating elements 12 and output amperage supplied to fans 32 and fan speed of fans 32 to deliver a specific amount of cubic feet per minute (CFM) air flow over heating elements 12 in order to simulate a specific amount of data center heat load.

In one embodiment, control device 22 is associated with at least one monitor 18a-18c and is configured to receive information based on the measured environmental parameters from the respective monitors 18a-18c. Data processing computer 20 provides operating instructions based, in part, on information representative of rack 16 environmental parameters measured by monitors 18a-18c in order to satisfy the thermal demand. Data processing computer 20 is further configured to provide control instructions based on stored information of system 100 components including heating elements 12, fans 32, and power regulating devices 14, for example. Data processing computer 20 receives information based on the measured environmental parameters.

System 100 is configured to adjust and satisfy local thermal demand criteria and overall thermal demand criteria. System 100 is operable to control heat generation in a stepless, or linear, manner using ongoing (e.g., continuous or intermittent) measured environmental parameter data. System 100 is operable to control the generation of heat in multiple heating elements 12 in multiple racks 16 from very low levels to very high levels. In one embodiment, power regulating device 14 regulates the range of power output proportionally to preset values of the environmental parameters, such as temperature, pressure, and air velocity. Control device 22 is configured to accept preset values of environmental parameters, such as measured temperature, pressure or air velocity to control amounts from power output of power regulating device 14 in a continuous manner and within an initially set power range. Specific amounts of heat can be generated at exact locations by specific heating devices 12 as directed by control device 22. In one embodiment, multiple control devices 22 are employed in system 100 and controlled by data processing computer 20, with each of the multiple control devices 22 electrically connected and configured to control at least one power regulating device 14 to regulate specific amounts of heat generated at exact locations.

In one embodiment, a separate power regulating device 14 is provided for each rack 16. Power regulating device 14 is electrically coupled to multiple heating elements 12 and fans 32 housed in a single rack 16 or in multiple racks 16. In one embodiment, heating elements 12 and fans 32 are positioned within enclosures 34 in racks 16. To provide power and protection to power regulating devices 14, power regulating devices 14 are electrically coupled to a power system protection and disconnecting device 40, which in turn, is electrically coupled to a power source bus 38. In this manner, the equipment in racks 16 is configured to be energized.

Data communication bus 36 provides for communication between data processing computer 20, control device 22, and monitors 18a-18c. Data acquired by monitors 18a-18c is communicated to data processing computer 20. After processing data received from monitors 18a-18c and any other data or instructional input, data processing computer 20 communicates operating instructions to control device 22. Control 22 can also communicate with data processing computer 20 to provide control input information, for example.

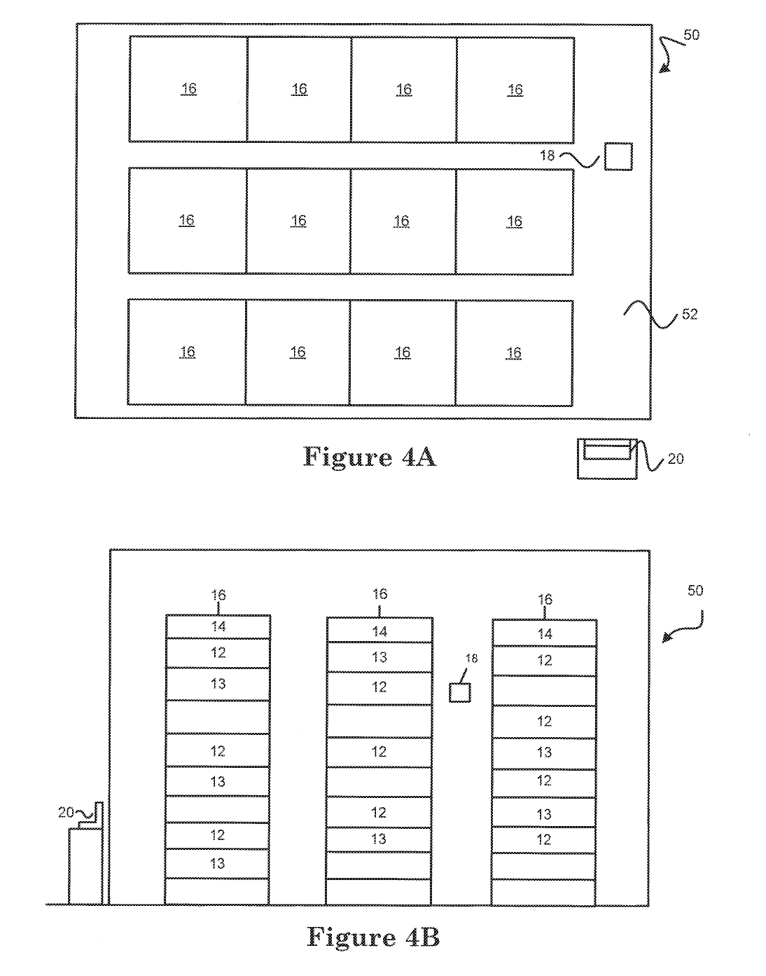

FIGS. 4A and 48 illustrate an example system 50 for controlling heat delivery in a data center 52. System 50 is configured to provide simulated control instructions for operating heating elements 12 based at least partially on acquired environmental parameters. FIG. 4A is plan view and FIG. 4B is an elevation view of data center 52. A series of racks 16 housing power regulating devices 14, heating elements 12, and fans 32 are positioned in rows within data center 52. At least one monitor 18 is strategically positioned within data center 52 to monitor environmental parameter data within data center 52 and communicate the environmental parameter data to data processing computer 20.

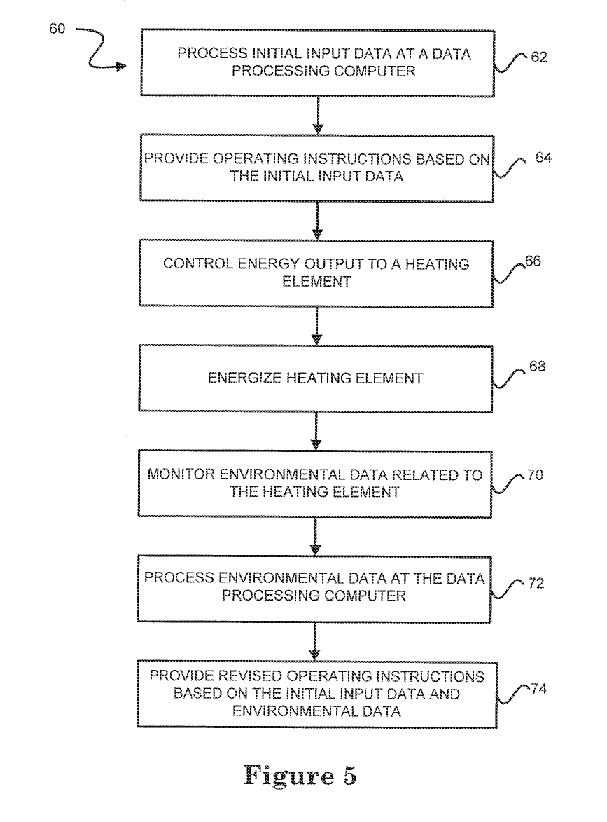

FIG. 5 is a flow chart illustrating an example method 60 for controlling heat delivery. At 62, initial input data is processed at data processing computer 20. At 64, operating instructions are provided based on the initial input data. At 66, energy output to heating element 12 is controlled. At 68, heating element 12 is energized. At 70, environmental data related to heating element 12 is monitored. At 72, environment data is processed at data processing computer 20. At 74, revised operating instructions are provided based on the initial input data and environmental data.

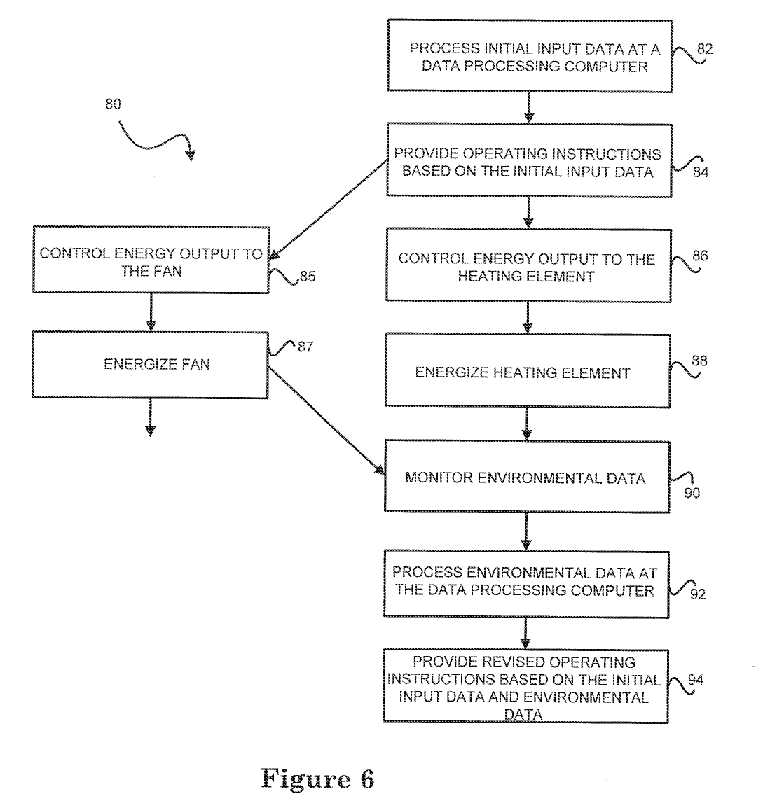

FIG. 6 is a flow chart illustrating an example method 80 for controlling heat delivery. At 82, initial input data is processed at data processing computer 20. At 84, operating instructions are provided based on the initial input data. At 86, energy output to heating element 12 is controlled. At 85, energy output to heating to fan 32 is controlled. Energy output to heating element 12 and fan 32 can be controlled simultaneously. At 88, heating element 12 is energized. At 87, fan 32 is energized. Heating element 12 and fan 32 can be energized correspondingly with one another or can be energized simultaneously. At 90, environmental data is monitored. At 92, environment data is processed at data processing computer 20. At 94, revised operating instructions are provided based on the initial input data and environmental data.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system for controlling heat delivery, comprising:
at least one heating element to generate heat;
at least one power regulating device to regulate the amount of energy output to the at least one heat element;
at least one monitor device to measure environmental parameter data of the at least one power regulating device and the at least one heating element;
a data processing computer to process environment parameter data from the at least one monitor and initial setting data and provide operating instructions; and
at least one control device to receive the operating instructions from the data processor and control the at least one power regulating device to regulate energy output to the at least one heating element.

2. The system of claim 1, comprising at least one fan, wherein the at least one power regulating device is configured to regulate the amount of energy output to the at least one fan.

3. The system of claim 2, wherein the at least one power regulating device independently regulates the amount of energy output to each of the at least one heating element and the at least one fan.

4. The system of claim 3, wherein the at least one heating element includes multiple heating elements and the at least one fan includes multiple fans, and wherein the power regulating device is configured to regulate the energy output to each of the multiple heating elements and each of the multiple fans independently.

5. The system of claim 1, comprising at least one rack to house the at least one power regulating device and the at least one heating element.

6. The system of claim 5, wherein the at least one rack includes multiple racks configured in a data center, each of the at least one racks housing multiple of the at least one heating elements.

7. The system of claim 5, wherein the at least one fan includes multiple fans housed in at least one of the multiple racks.

8. The system of claim 5, wherein one of the at least one power regulating devices is configured to regulate the amount of energy output to each of the multiple heating elements and each of the multiple fans housed in one of the at least one rack.

9. A method of controlling heat delivery, comprising:
processing initial input data with a data processing computer;
providing operating instructions from the data processing computer based on the initial input data;
controlling energy output to at least one heating element based on the operating instructions;
energizing the at least one heating element with the energy;
monitoring environmental data related to the at least one heating element;
processing the environmental data at the data processing computer; and
providing revised operating instructions based on the initial input data and the environmental data.

10. The method of claim 9, comprising:
adjusting the energy output to the at least one heating element to correspond to the revised operating instructions.

11. The method of claim 9, wherein the monitoring of environmental data is ongoing during the at least one heating element energization.

12. The method of claim 9, wherein the energy output is linearly controlled based on the revised operating instructions.

13. The method of claim 9, comprising:
energizing at least one fan; and
controlling energy output to the at least one fan.

14. The method of claim 13, comprising:
independently adjusting the energy output to each of the at least one heating element and the at least one fan corresponding to the revised operating instructions.

15. The method of claim 9, wherein the monitoring of environmental data includes monitoring air velocity, air pressure, and temperature.
